(19) United States
(12) Patent Application Publication
(10) Pub. No.: US 2003/0079039 A1
(43) Pub. Date: Apr. 24, 2003

(54) Web server utilizing a state machine and user token

(76) Inventors: Damien R. Forkner, Corvallis, OR (US); Jeffrey M. Munsey, NE Albany, OR (US)

Correspondence Address: HEWLETT-PACKARD COMPANY, Intellectual Property Administration, P.O. Box 272400, Fort Collins, CO, 80527-2400, US

(21) Appl. No.: 09/978,805

(22) Filed: Oct. 16, 2001

(51) Int. Cl. G06F 15/16

(52) U.S. Cl. 709/237; 709/203

(57) ABSTRACT

Dialog state between a client and a server is tracked. When sending a communication from the server to the client, dialog state for a dialog between the client and the server is stored in storage within the server. A key is included in the communication from the server to the client. The key references a storage location within the server in which the dialog state is stored.

### BACKGROUND OF THE INVENTION

The present invention pertains to obtaining information through a network and pertains particularly to a reliable web server that uses a state machine and user token.

The Internet started as a cooperative research effort of the United States Federal Government known as the Advanced Research Project Agency Network (ARPAnet). The ARPAnet tied universities and research and development organizations to the U.S. military establishment. More recently, the Internet has extended its use commercially and internationally. It is the world's largest computer network.

A Uniform Resource Locator (URL) address is an Internet address. A URL address consists of a string expression that designates a resource (referred to herein as a URL page) on the Internet. For example, the resource is a particular file on a computer connected to the Internet.

Web browsers such as Netscape Navigator browser available from Netscape, and Internet Explorer browser available from Microsoft Corporation use URL addresses to access resources (URL pages) on the Internet. The World Wide Web (Web) allows users to navigate Internet resources intuitively, without using internet protocol (IP) addresses or other special technical knowledge. The Web is made up of interconnected web pages, or web documents stored on web servers. These pages are accessed with the use of a web browser.

The Web uses a transfer method known as Hypertext Transfer Protocol (HTTP). One format for information transfer is to create documents using Hypertext Markup Language (HTML). HTML pages are made up of standard text as well as formatting codes that indicate how the page should be displayed. A web browser reads these codes in order to display the page.

Each Web page may contain graphics, video and audio information in addition to text. Hidden behind certain text, pictures or sounds are connections, known as hypertext links (links), to other pages within the same web server or on other computers within the Internet. Each link is directed to a web page by a Uniform Resource Locator (URL). A user may also specify a known URL by writing it directly into the command line of a web. browser.

In existing web browser client to web server dialogs, when a client browser proceeds non-sequentially, for example when a users uses the “back” feature of a web browser, the web server may be left in an unstable or a confused state. An unstable or a confused state can also result when a web browser client accesses a web server in the middle of a sequence of processes. The result is the client state information does not map to a valid state on the web server.

Many web servers track user information as cookies. A cookie is a small text file placed on a client's hard disk. Cookies typically contain information about the user and user preferences for a Web site. For example, if a user looks at a flight schedule on an airline's Web site, the site might create a cookie that records the pages visited on the site. That way, the site can customize the pages seen by the user at the next visit to the web site. A cookie stores information provided by the user, or the choices made by the user when visiting a Web site. Cookies can also store information that the server sends.

In addition to cookies, it is possible for a web server to use dynamic information (tokens or hidden state information) to track user information. However, in systems that generate dynamic content, adding extra dynamic pages increases the complexity of the code dramatically, because the entire state must be passed around from page to page. Additionally, since server controls and the “state” of a session is maintained in the client, this information can be easily decoded and simulated using a web browser's View Source function, opening dangerous security holes.

### SUMMARY OF THE INVENTION

In accordance with the preferred embodiment of the present invention, dialog state between a client and a server is tracked. When sending a communication from the server to the client, dialog state for a dialog between the client and the server is stored in storage within the server. A key is included in the communication from the server to the client. The key references a storage location within the server in which the dialog state is stored.

### BRIEF DESCRIPTION OF THE DRAWINGS

FIG. 1 is a simplified block diagram illustrating a dialog between a client web browser and a web server in accordance with the prior art.

FIG. 2 is a simplified block diagram illustrating a dialog between a client web browser and a web server in accordance with a preferred embodiment of the present invention.

FIG. 3 is a simplified flow chart that illustrates operation of a web server to track dialog state in a web server state cache in accordance with a preferred embodiment of the present invention.

### DETAILED DESCRIPTION OF THE PREFERRED EMBODIMENT

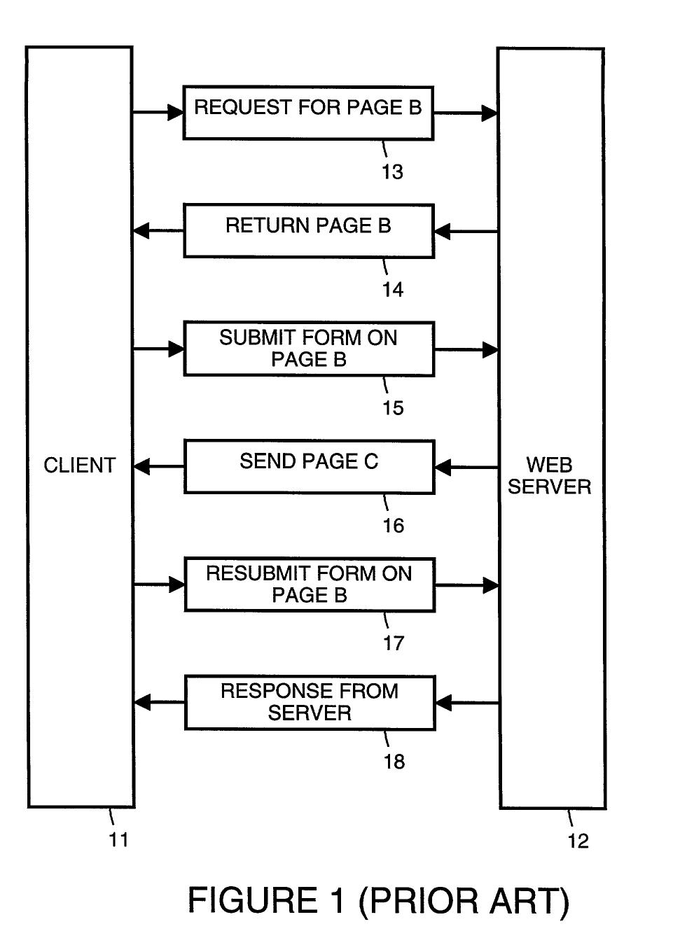

FIG. 1 is a simplified block diagram illustrating a dialog between a client web browser 11 and a web server 12 in accordance with the prior art. As illustrated by box 13, client web browser 11 makes a request for an interactive Common Gateway Interface (CGI) page (Page B) from web server 12. As illustrated by a box 14, web server 11 returns back Page B as a CGI-enabled page with a number of form controls contained in the page. Embedded hidden variables in Page B define the sent page as Page B and tell web server 12 what should be done with data when client web browser 11 submits the form.

As illustrated by a box 15, client web browser 11 submits the form on Page B when a user clicks a submit button within Page B as displayed on client web browser 11. Web server 12 uses encoded information from Page B to manipulate a database and generates a page C. As illustrated by a box 16, web server 12 sends page C back to client web browser 11.

If, for example, the users hits the “Back” button in client web browser 11, web browser 11 pulls a copy of Page B from cache and displays Page B to the user. As illustrated by a box 17, client web browser 11 re-submits the form on Page B when a user again clicks the submit button within Page B. Upon receiving resubmitted Page B, web server 12 becomes confused. As illustrated by box 18, a response is sent to client web browser 11 from web server 12; however, the results returned to client web browser 11 may or may not be the results anticipated by the user.

Using the present invention, invalid operations are detected and avoided. In traditional systems, it is nearly impossible to detect when a user has pressed Back, Forward, reloaded a page, or submitted a form twice by clicking on the button twice. All of these events can lead to unpredictable results in a complicated multi-step form, and all can be detected and avoided using the user token model described below.

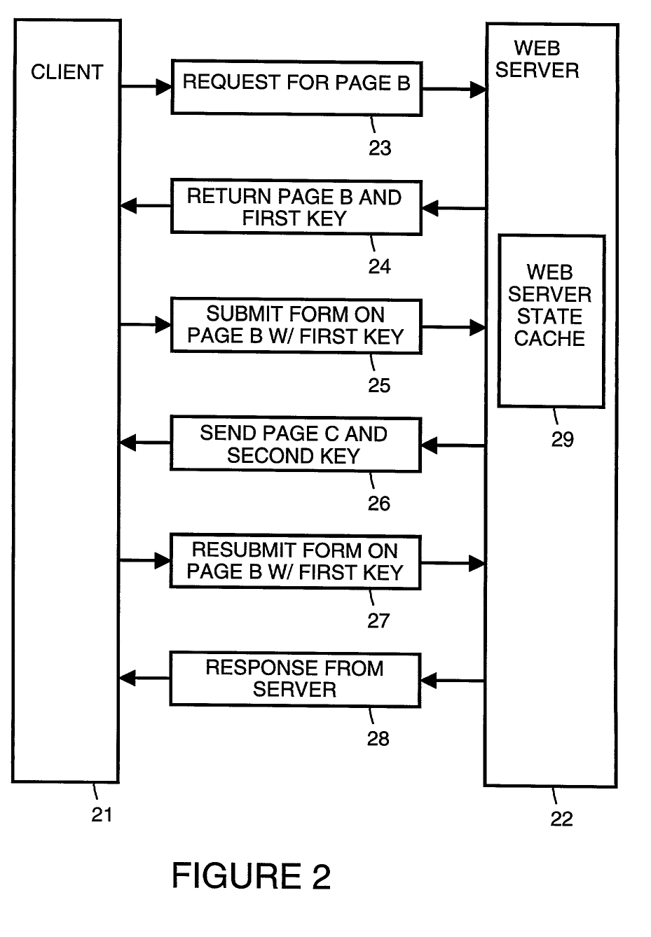

In FIG. 2 a web server state cache 29 is added to a web server 22 allowing web server 22 to track the state of a dialog with a client web browser 21. As illustrated by box 23, client web browser 21 makes a request for an interactive CGI page (Page B) from web server 22. Web server 22 generates a token, i.e., a unique key (first key), corresponding to Page B and client web browser 21. Web server 22 also makes an entry into web server state cache 29 for the first key as illustrated by the entry in Table 1 below. Use of such entries in effect implements a state machine.

TABLE 1

Entry for First Key
Page B
Expires 07/01/01 at 3:00 PM PST
Client: John Doe
Next Action: Create Page C

As illustrated by a box 24, web server 21 returns back Page B as a CGI-enabled page. The first key is embedded in page B.

As illustrated by a box 25, client web browser 21 submits the form on Page B when a user clicks a submit button within Page B as displayed on client web browser 21. The first key is also sent back to web server 22 along with page B. Web server 22 looks up in web server state cache 29 the entry for the first key. The entry instructs web server 22 to generate Page C. Web server 22 uses encoded information from Page B to generate a page C.

Web server 22 changes the entry for the first key in web server state cache 29 to indicate the first key has been accessed. Web server state cache 29 also makes a new entry into web server state cache 29 for a second key. Theses two entries are illustrated by the entries set out in Table 2 below:

TABLE 2

Entry for First Key
Page B
Already Accessed
Client: John Doe
Entry for Second Key
Page C
Expires 07/01/01 at 3:30 PM PST
Client: John Doe
Next Action: Create Page D

As illustrated by a box 26, web server 22 sends page C back to client web browser 21. The second key is embedded in page C.

If, for example, the users hits the “Back” button in client web browser 21, web browser 21 pulls a copy of Page B from cache and displays Page B to the user. As illustrated by a box 27, client web browser 21 re-submits the form on Page B when a user again clicks the submit button within Page B. The first key is also sent back to web server 22 along with page B.

Upon receiving resubmitted Page B, web server 22 looks up in web server state cache 29 the entry for the first key. The entry indicates to web server 22 that Page B has been received out of sequence and has already been accessed. This allows web server 22 to take an appropriate corrective action. For example, web server 22 sends back to client browser 21 an appropriate error page. Alternatively, web server 22 directs the user of client browser 21 back to page C. In this way the user receives predictable results.

Using the web server state cache allows long, complicated forms to be broken up into many steps without excessive code complication. The web server state cache also permits complex state machines to be implemented without the complexity associated with storing state information on the client web browser. Also, using the web server state cache prevents unauthorized access to dynamic content. Server controls and the “state” of a session are no longer maintained in the client. The web server state cache permits pages to be generated only in the order allowed and maintained by web server state cache 29. Requests cannot be simulated or decoded.

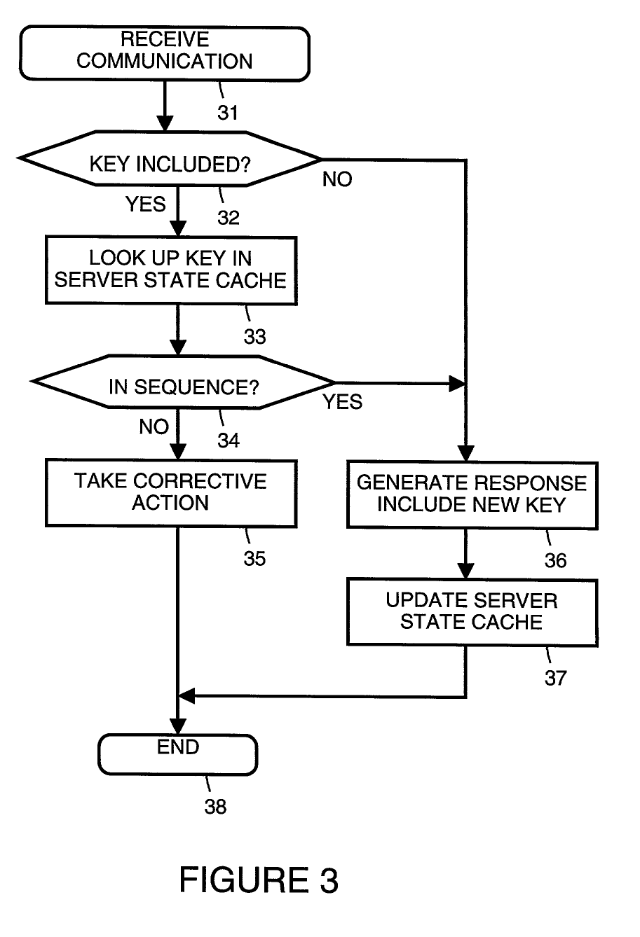

FIG. 3 is a simplified flow chart that illustrates operation of web server 22 to track dialog state in web server state cache 29. In a step 31, web server 22 receives a communication from a client web browser. In a step 32, web server 22 checks to see if a key is included. If in step 32 it is determined that a key is included, in a step 33, web server 22 looks up the key in web server state cache 29. In a step 34, web server 22 checks the entry for the key in web server state cache 29 to see if the page was received in sequence. If in step 34 it is determined that the page was not received in sequence, in a step 35, web server 22 takes corrective action.

If in step 32 it is determined that a key is not included, a step 36 is performed. Also, if in step 34 it is determined that the page was received in sequence, step 36 is performed. In step 36 a response is generated to the client web browser. A new key is included in the response sent from the web server to the client web browser. In a step 37, web server 22 updates web server state cache 29 with an entry for the new key.

In a step 38, the process for handling the communication is completed.

The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

What is claimed is:

1. A method for tracking dialog state between a client and a server comprising the following step:
(a) when sending a communication from the server to the client, performing the following substeps:
(a.1) storing dialog state for a dialog between the client and the server, the dialog state being stored in storage within the server, and
(a.2) sending a key from the server to the client, the key referencing a storage location within the server in which the dialog state is stored.

2. A method as in claim 1 wherein in step (a.2) the key is embedded within a page sent from the server to the client.

3. A method as in claim 1 wherein the client is a web browser client and the server is a web server.

4. A method as in claim 1 wherein in substep (a.1) the storage within the server is a server state cache.

5. A method as in claim 1 additionally comprising the following step:
(b) when a message is received by the server from the client, performing the following substeps by the server:
(b.1) checking to determine whether the key is included in the message, and
(b.2) when the key is included in the message, using the key to access the storage location to obtain the dialog state.

6. A method as in claim 1 additionally comprising the following step:
(b) when a message is received by the server from the client, performing the following substeps by the server:
(b.1) checking to determine whether the key is included in the message,
(b.2) when the key is included in the message, using the key to access the storage location to obtain the dialog state,
(b.3) checking the dialog state to determine whether the message is in correct sequence, and
(b.4) when the message is not in correct sequence, taking corrective action.

7. A method as in claim 1 additionally comprising the following step:
(b) when a message is received by the server from the client, performing the following substeps by the server:
(b.1) checking to determine whether the key is included in the message,
(b.2) when the key is included in the message, using the key to access the storage location to obtain the dialog state,
(b.3) checking the dialog state to determine whether the message is in correct sequence,
(b.4) when the message is not in correct sequence, taking corrective action.
(b.5) when the message is in correct sequence, generating a response to the client, the response including a new key, and
(b.6) storing new dialog state for the dialog between the client and the server, the dialog state being stored in the storage within the server at a new storage location accessible to the server using the new key.

8. A method as in claim 1 additionally comprising the following step:
(b) when a message is received by the server from the client, performing the following substeps by the server:
(b.1) checking to determine whether the key is included in the message,
(b.2) when the key is included in the message, using the key to access the storage location to obtain the dialog state,
(b.3) generating a response to the client, the response including a new key, and,
(b.4) storing new dialog state for the dialog between the client and the server, the dialog state being stored in the storage within the server at a new storage location accessible to the server using the new key.

9. A method as in claim 1 additionally comprising the following step:
(b) when a message is received by the server from the client, performing the following substeps by the server:
(b.1) generating a response to the client, the response including a new key, and,
(b.2) storing new dialog state for the dialog between the client and the server, the dialog state being stored in the storage within the server at a new storage location accessible to the server using the new key.

10. A method for tracking dialog state between a client and a server comprising the following steps
(a) when a message is received by the server from the client, performing the following substeps by the server:
(a. 1) checking to determine whether a key is included in the message, and,
(a.2) when a key is included in the message, using the key to access a dialog state from storage within the server.

11. A method as in claim 10 wherein step (a) additionally comprises the following substeps:
(a.3) checking the dialog state to determine whether the message is in correct sequence, and
(a.4) when the message is not in correct sequence, taking corrective action.

12. A method as in claim 10 wherein step (a) additionally comprises the following substeps:
(a.3) checking the dialog state to determine whether the message is in correct sequence,
(a.4) when the message is not in correct sequence, taking corrective action.
(a.5) when the message is in correct sequence, generating a response to the client, the response including a new key, and
(a.6) storing new dialog state for the dialog between the client and the server, the dialog state being stored in the storage within the server at a new storage location accessible to the server using the new key.

13. A method as in claim 10 wherein step (a) additionally comprises the following substeps:
(a.3) generating a response to the client, the response including a new key, and,
(a.4) storing new dialog state for the dialog between the client and the server, the dialog state being stored in the storage within the server at a new storage location accessible to the server using the new key.

14. A method as in claim 10 wherein the client is a web browser client and the server is a web server.

15. A method as in claim 10 wherein in substep (a.2) the storage within the server is a server state cache.

16. A server that tracks dialog state for communication between a client and the server, the server comprising:
a server state cache, the server state cache being used by the server to store dialog state for a dialog between the client and the server, so that when the server sends a communication to the client, the server sends with the communication a key, the key referencing a storage location within the server state cache in which the dialog state is stored.

17. A server as in claim 1 wherein the client is a web browser client and the server is a web server.

18. A server as in claim 1 wherein when a message is received by the server from the client, the server checks to determine whether the key is included in the message, and when the key is included in the message, the server uses the key to obtain the dialog state from server state cache.

19. A server that tracks dialog state for communication between a client and the server, the server comprising:
a server state cache, the server state cache being used by the server to store dialog state for a dialog between the client and the server, so that when a message is received by the server from the client, the server checks to determine whether a key is included in the message, and when the key is included in the message, the server uses the key to obtain the dialog state from server state cache.

20. A server as in claim 19 wherein the client is a web browser client and the server is a web server.
